(19) United States
(12) Patent Application Publication
(10) Pub. No.: US 2023/0259788 A1
(43) Pub. Date: Aug. 17, 2023

(54) GRAPHICAL DESIGN OF A NEURAL NETWORK FOR ARTIFICIAL INTELLIGENCE APPLICATIONS

(71) Applicant: VADIM EELEN, PARIS, OH (US)

(72) Inventor: VADIM EELEN, PARIS, OH (US)

(21) Appl. No.: 18/107,805

(22) Filed: Feb. 9, 2023

Related U.S. Application Data
(60) Provisional application No. 63/309,051, filed on Feb. 11, 2022.

(51) Int. Cl. G06N 3/09; G06N 3/0464

(52) U.S. Cl. CPC G06N 3/09; G06N 3/0464

(57) ABSTRACT

Disclosed embodiments provide a graphical system for capturing and development of datasets, and designing, training, and deploying neural networks. A graphical editor allows a user to assemble and connect various layers into a neural network. Machine code is then generated based on the assembled graph. The machine code can be interpreted code such as Python. A plurality of pre-made datasets can be used to train the neural network. Once trained, the neural network is deployed by hosting it on a server and exposing one or more APIs and/or listeners to enable sending and receiving of data and information between the neural network and one or more AI-enabled systems.

### FIELD

The present invention relates generally to machine learning, and more particularly to the graphical design of a neural network for the development of artificial intelligence applications.

### BACKGROUND

Artificial Intelligence (AI) systems implementing neural networks may be designed, constructed, and trained to perform a wide variety of decision-making processes and predictive assessments. Such neural networks may be implemented as data structures including a plurality of nodes along with a defined set of interconnections between pairs of nodes, and a weight value associated with each interconnection. These neural networks may be structured in layers, for example, a first layer of input nodes, one or more layers of internal nodes (hidden layers), and a layer of output nodes. Once a neural network has been generated and trained with an appropriate training data set, it may be used to perform decision-making processes and predictive assessments for a wide variety of applications. For instance, a trained neural network may be deployed within a content distribution network and used to perform tasks such as detecting patterns, predicting user behavior, data processing, function approximation, and the like. An increasing number of systems are relying on artificial intelligence for efficient operation.

There are several benefits of using AI-enabled applications. One such benefit is increased efficiency. AI can automate certain tasks and make processes more efficient, freeing up time and resources for more important tasks. Another benefit is improved accuracy. AI algorithms can analyze large amounts of data and identify patterns that humans might miss, leading to more accurate predictions and decisions. AI can also improve customer experience by providing personalized experiences for customers, such as personalized recommendations or real-time support. Additionally, AI can assist with tasks such as scheduling, data entry, and customer service, allowing employees to enable increased productivity. Furthermore, AI can help contribute to operational cost savings by automating certain tasks, reducing labor costs and leading to cost savings for businesses. However, implementing Artificial Intelligence (AI) enabled systems requires deep knowledge of subject matter and is quite time-consuming even for an experienced AI programmer. It is therefore desirable to have innovations in AI tools and the design of programming processes for development of AI-enabled systems.

### SUMMARY

Disclosed embodiments provide a graphical system and tools for capturing, analyzing, and developing AI Datasets as well as designing, training and deploying neural networks onto dedicated computer vision hardware or for further deployment of AI Applications onto third-party hardware/software devices and applications. A graphical editor allows a user to assemble and connect various layers into a neural network.

Embodiments can include a computer-implemented method for creating a neural network, comprising: receiving instructions for rendering a graphical representation of a neural network, wherein the graphical representation comprises a plurality of nodes interconnected by a plurality of edges; converting the graphical representation into source code; training the neural network; and deploying the neural network.

Additional embodiments can include an electronic computation device comprising: a processor; a memory coupled to the processor, the memory containing instructions, that when executed by the processor, cause the electronic computation device to perform the steps of: receiving instructions for rendering a graphical representation of a neural network, wherein the graphical representation comprises a plurality of nodes interconnected by a plurality of edges; converting the graphical representation into source code; training the neural network; and deploying the neural network.

Yet other embodiments can include a computer program product for an electronic computation device comprising a computer readable storage medium having program instructions embodied therewith, the program instructions executable by a processor to cause the electronic computation device to: receive instructions for rendering a graphical representation of a neural network, wherein the graphical representation comprises a plurality of nodes interconnected by a plurality of edges; convert the graphical representation into source code; train the neural network; and deploy the neural network.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

Often, similar elements may be referred to by similar numbers in various figures (FIGs) of the drawing, in which case typically the last two significant digits may be the same, the most significant digit being the number of the drawing figure (FIG). Furthermore, for clarity, some reference numbers may be omitted in certain drawings.

FIG. 1 shows a block diagram of disclosed embodiments.

FIG. 2 is a block diagram of a client device in accordance with embodiments of the present invention.

FIG. 3 is a flowchart indicating process steps for embodiments of the present invention.

FIG. 4 illustrates a usage example.

FIG. 5 shows an example of a graphical editor environment in accordance with disclosed embodiments.

FIG. 6 shows a block diagram of additional embodiments.

FIG. 7 is an application creation workflow in accordance with disclosed embodiments.

FIG. 8 is a block diagram indicating a neural network design process in accordance with disclosed embodiments.

FIG. 9 is a diagram indicating use of disclosed embodiments in a manufacturing application.

### DETAILED DESCRIPTION

Disclosed embodiments provide a no-code, low entry-level Artificial Intelligence Software as a Service and computer vision hardware for the development of AI applications from idea to production. Embodiments can create powerful AI applications without the need for a user to use a single line of programming code or have prior experience creating AI applications. In particular, disclosed embodiments are well-suited for manufacturing operations, such as inspection of workpieces at intermediate phases and/or completion. The computer vision hardware and machine learning solution provided by disclosed embodiments can serve to help improve the technical field of AI applications, and particularly directed to applications for manufacturing and workpiece inspection.

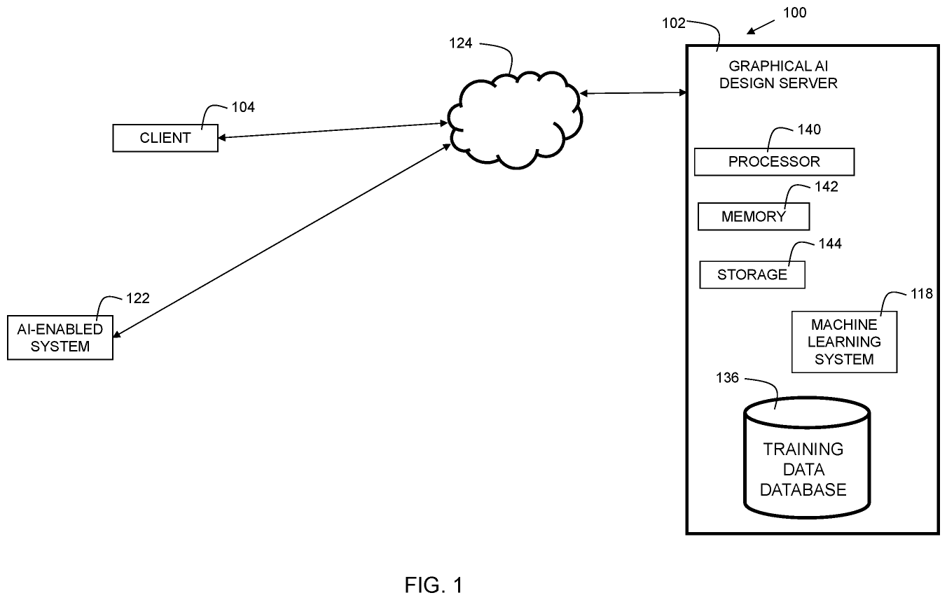

FIG. 1 shows a block diagram of disclosed embodiments. FIG. 1 is a block diagram of a system in accordance with embodiments of the present invention. System 100 includes a graphical AI (artificial intelligence) design server (GAIDS) 102. GAIDS 102 is an electronic computation device. In embodiments, the GAIDS 102 is implemented as a computer comprising a processor 140, and memory 142 coupled to the processor. The memory 142 may be a non-transitory computer readable medium. Memory 142 may include RAM, ROM, flash, EEPROM, or other suitable storage technology. The memory 142 contains instructions that when executed by processor 140, enable communication with a variety of other devices and data stores. In embodiments, network 124 may include the Internet.

Storage 144 may include one or more magnetic hard disk drives (HDD), solid state disk drives (SSD), optical storage devices, tape drives, and/or other suitable storage devices. In embodiments, storage 144 may include multiple hard disk drives configured in a RAID (redundant array of independent disks) configuration, or other suitable configuration to ensure robust data integrity.

In some embodiments, the GAIDS 102 may be implemented as a virtual machine (VM), or scaled to be implemented on multiple virtual machines and/or containerized applications. In some embodiments, the virtual machines may be hosted in a cloud computing environment. In some embodiments, load balancing, and orchestration via a system such as Kubernetes, enables a scalable solution that can process input data from a variety of sources simultaneously.

Cloud computing is a model of computing in which computing resources are provided as a service over the internet, rather than as a product installed on a local device. Cloud computing enables users to access and use virtualized computing resources that can be easily scaled up or down as needed, without the need to invest in physical infrastructure or worry about maintenance and updates. There are several different types of cloud computing services, including Infrastructure as a Service (IaaS). This type of cloud service provides users with access to virtualized computing infrastructure, such as servers, storage, and networking, which they can use to run their own applications and services. Another cloud computing service type is Platform as a Service (PaaS). This type of cloud service provides users with a platform for building, deploying, and managing applications, without the need to worry about underlying infrastructure. Yet another type of cloud service is Software as a Service (SaaS). This type of cloud service provides users with access to software applications over the internet, typically on a subscription basis. Disclosed embodiments can be implemented utilizing one or more of the aforementioned cloud service types.

A client device 104 is also connected to network 124. In embodiments, client device 104 may include, but is not limited to, a desktop computer, a laptop computer, a tablet computer, a mobile phone (e.g., smartphone), and/or other suitable electronic computing device. Note that while one client device 104 is shown in FIG. 1, in practice, multiple client devices may concurrently establish connections with GAIDS 102 in accordance with embodiments of the present invention. In embodiments, the client device 104 can be used to interact with the GAIDS 102, to graphically build, train, and deploy neural networks. The deployment can include loading the neural network on a cloud-based computer network and exposing application programming interface (API) functions to enable client devices to interact with the neural network.

The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet can be provided by Internet service providers (ISP). Users on client systems, such as client device 104 obtains access to the Internet through the Internet service providers. Access to the Internet allows users of the client computer systems to exchange information, receive and send e-mails, and view documents, such as documents which have been prepared in the HTML format. These documents are often provided by web servers which are considered to be “on” the Internet.

System 100 may further include a training data database 136. The training data database 136 may comprise multiple records, where each record includes entities such as raw data, as well as metadata. The metadata may include descriptive tags and/or other classifications to organize the training data. In some embodiments, some of the training data may be used for validating a neural network.

System 100 further includes a machine learning system 118. Machine learning system 118 can be used to categorize and classify input data by providing it to one or more prebuilt trained neural networks embedded into application or custom-designed by a user from scratch. The input data can include image data, video data, audio data, and/or other types of data, including data acquired from IoT sensors, humans, animals, scenery, object recognition and/or object classification, person recognition, natural language processing (NLP), sentiment analysis, and/or other classification processes. Machine learning system 118 may include one or more neural networks, convolutional neural networks (CNNs), and/or other deep learning techniques. The machine learning system 118 may include tools that allow management and control of regression algorithms, classification algorithms, clustering techniques, anomaly detection techniques, Bayesian filtering, and/or other suitable techniques to analyze the data provided to it.

System 100 may further include an AI-enabled system 122. The AI-enabled system can include network-enabled digital video cameras, audio sensors, robots, autonomous vehicles, and/or other systems that utilize AI for operation. Data from the AI-enabled system 122 via network 124 may be processed by machine learning system 118, results may be returned to the AI-enabled system via network 124. In embodiments, one or more APIs, and/or listeners may be established by the part of the GAIDS 102 via the machine learning system 118, to facilitate data and/or information exchange between the AI-enabled system 122 and the GAIDS 102 machine learning system 118.

In some embodiments, the GAIDS 102 machine learning system 118, and/or database 136 via application programming interface (API) calls can interface with the AI client 104 and AI-enabled system 122. Communication between the elements shown in FIG. 1 can include the use of protocols such as HTTP (HyperText Transfer Protocol), XML (Extensible Markup Language), JSON (JavaScript Object Notation), SOAP (Simple Object Access Protocol), RESTful APIs, and/or other suitable technologies. The GAIDS 102 may include and/or utilize multiple computer systems, databases, load balancers, and other infrastructure to support analysis of data from the AI-enabled system 122.

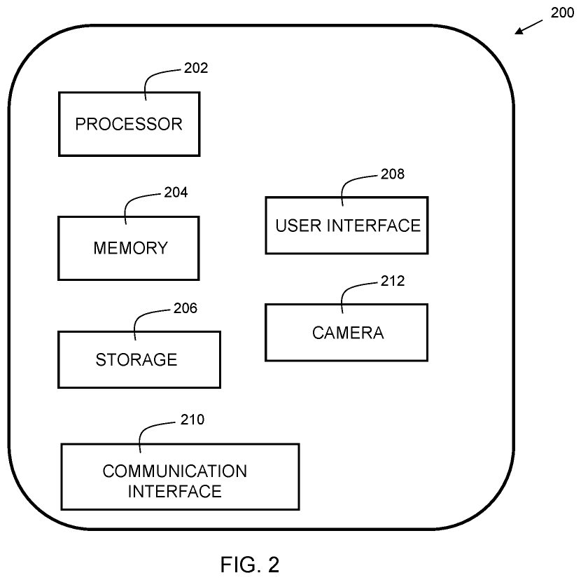

FIG. 2 is a block diagram of a client device 200 in accordance with embodiments of the present invention. In embodiments, client device 200 is an electronic device that may include a desktop computer, laptop computer, tablet computer, smartphone, and/or other suitable client device. Client device 200 may be similar to client device 104 as shown in FIG. 1. Client device 200 includes a processor 202, a memory 204 coupled to the processor 202, and storage 206. The memory 204 may be a non-transitory computer readable medium. Memory 204 may include RAM, ROM, flash, EEPROM, or other suitable storage technology. The memory 204 contains instructions, that when executed by processor 202, enable communication to/from GAIDS 102 of FIG. 1. Client device 200 further includes a network communication interface 210 for performing this communication. In embodiments, network communication interface 210 includes a wireless communications interface such as a cellular data interface and/or a Wi-Fi interface. In embodiments, the storage 206 includes flash, SRAM, one or more hard disk drives (HDDs) and/or solid-state disk drives (SSDs).

Device 200 may further include a user interface 208. User interface 208 may include a keyboard, monitor, mouse, and/or touchscreen, and provides a user with the ability to enter information as necessary to utilize embodiments of the present invention. In embodiments, a user uses the device 200 to access a trained neural network residing on machine learning system 118 that was created by the GAIDS 102. Device 200 may further include a camera 212. The camera 212 may record both video and audio, and in some embodiments, data from the camera 212 may be provided to the machine learning system 118 and/or training data database 136. Furthermore, the device 200 may provide a rendering of a graphical editor environment for creating, editing, training, deploying, and/or administrating neural networks.

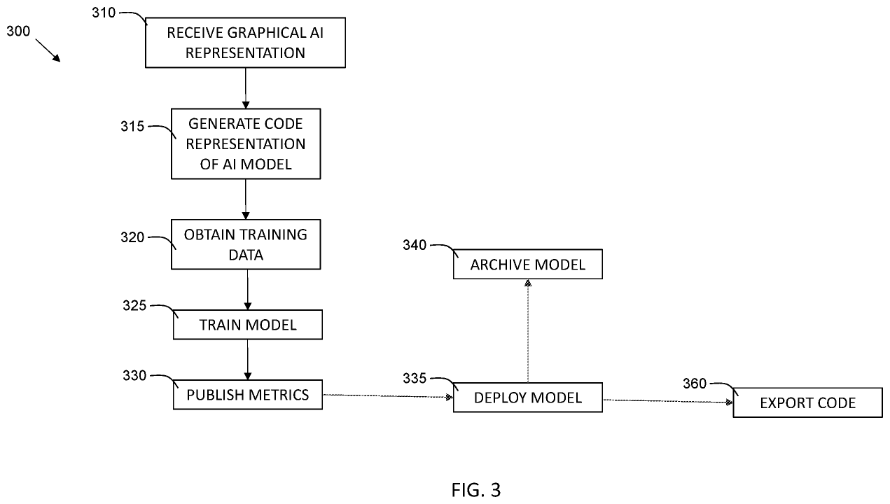

FIG. 3 is a flowchart 300 indicating process steps for embodiments of the present invention. At 310 a graphical AI representation is received. This can include one or more layers arranged in a directed graph format with nodes representing layers and edges indicating data flow. At 315 the graphical representation of the AI model is converted into source code having a code format such as Python. In embodiments, algorithm and software tools of the invention do that by using the processor 140 of the GAIDS 102 that performs this task.

At 320, training data is obtained. The training data may be captured by dedicated CV (Computer vision), made by using third party computer vision systems or dataset pre-trained by the GAIDS 102. As an example, pre-trained sets of data for various common applications such as human recognition, animal classification, plant classification, and the like, may be made available for a user to use to build his/her own neural network based on existing pre-trained neural networks models provided by the system. The graphical method can save many hours of development time as compared with traditional neural network implementation techniques. Alternatively, or additionally, user-provided datasets may also be used to train the neural network generated at 315. At 325, the neural network is trained using the obtained training datasets. The training process is accompanied by the system displaying the metrics that can include, but are not limited to, estimated training time, time to training completion, average epoch time, hardware resource utilization such as CPU utilization, memory utilization, and/or storage (disk) utilization but most importantly provides series of control graphs that provides visual representation of the results of the neural network model training in real time.

Disclosed embodiments can provide an option to change the size of a batch of data that is used in training. A user can choose a number of epochs (that will adjust the time that will be taken for actual learning and possibly improve the learning). Additionally, users can change parameters of output layers that during the learning process will monitor the net losses and show some other useful metrics that will help us to observe and analyze the learning process. The user also can change the default settings of how the learning checkpoint is displayed and how to better save the neural network.

At 330, neural network training metrics are published to the user, e.g., via a web page. At 335, the neural network (model) is deployed. The deployment can include deploying code to the machine learning system 118, and exposing APIs and/or listeners to enable exchange of data and information. Optionally, at 340, the neural network (model) may be archived in a reference library. Optionally, at 360, code, such as python code that was generated at 315 may be exported into a text based API code file, and executed on machine(s) of the user's choosing for implementation of the neural networks.

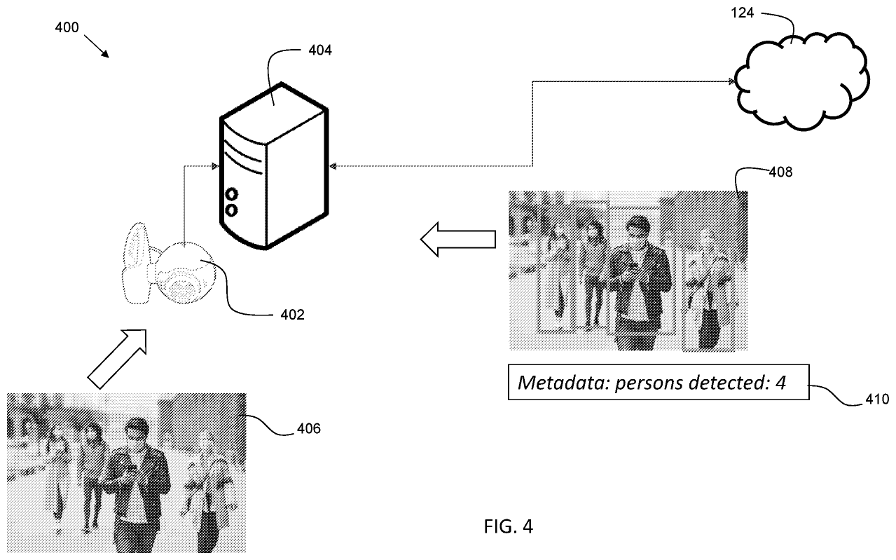

FIG. 4 illustrates a usage example. A surveillance system 400 includes a camera 402, and a computer 404. The camera 402 acquires digital images 406 as input. The computer 404 sends the images via network 124 to the machine learning system 118 (FIG. 1). The machine learning system 118 analyzes the input image 406, and returns output data. The output data can be an augmented image 408, and/or metadata 410 pertaining to the input image. The surveillance system 400 is a specific example of an AI-enabled system 122 (FIG. 1). While this example illustrates identification of humans, a wide variety of applications are possible, including object classification, natural language processing, image enhancement, and/or other applications suitable for machine learning and artificial intelligence.

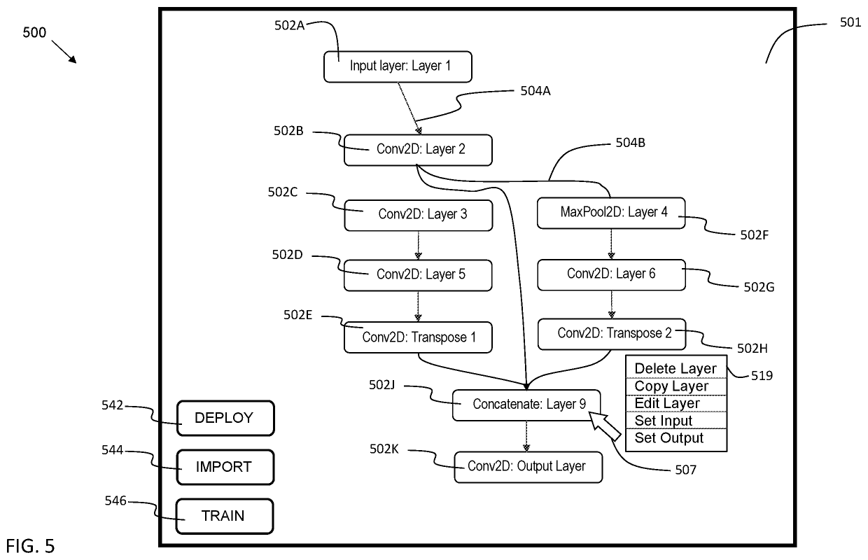

FIG. 5 shows an example of a graphical editor environment 500 in accordance with disclosed embodiments. In embodiments, a user may utilize a pointing device such as a mouse that controls a cursor 507, along with additional input from a computer keyboard to create, arrange and edit settings of neural network layers, indicated as 502A-502K on a drawing area 501. The user may then interconnect layers via a plurality of edges, indicated generally as 504A and 504B. Thus, in embodiments, the layers can be represented as a plurality of nodes interconnected by a plurality of edges. The drawing area may be rendered on an electronic display. For clarity, not all interconnects are labeled in FIG. 5.

The system is designed to allow graphical development of neural network layers that can include a wide variety of layers, including, but not limited to, Conv1D, Conv2D, Conv3D, Conv1DTranspose, convolutional 2D layer, Conv2DTranspose, Max Pooling, and/or Conv3DTranspose. Other layer types are possible in disclosed embodiments. For each layer, various neural network layers settings may be changed and selected via the graphical user interface. These parameters settings can include, but are not limited to, kernel size, kernel initializer, filters, strides, padding, and activation. The padding options can include valid and same. The activation options can include ReLU (Rectified Linear Unit), ELU (exponential linear unit), exponential, gelu, and hard sigmond. The kernel initializer options can include Random Normal, Random Uniform, Truncated normal, Zeros, Ones, Glorot normal, or other suitable initializer. The above-mentioned parameters are merely exemplary, and a wide variety of options and configurations are possible in disclosed embodiments.

The max pooling layer, indicated at 502F, is used to reduce the spatial size of the input data and extract the most important features from it. Max pooling layer 502F divides the input data into a grid of non-overlapping regions, and selects the maximum value from each region. This effectively performs downsampling of the data, reducing the spatial resolution and number of parameters in the model. Max pooling also helps to reduce overfitting by introducing spatial invariance, meaning that the model is less sensitive to the exact position of features in the input data.

Embodiments use max pooling in combination with convolutional layers, which apply a set of filters to the input data to extract features. The output of the convolutional layer is passed through a max pooling layer, which selects the most important features and reduces the spatial size of the data. This process can be repeated multiple times, with each successive max pooling layer further reducing the spatial resolution of the data and increasing the level of abstraction of the features.

In embodiments, optionally, cascading may be performed. The cascading can include selecting multiple archived models and indicating a data flow between them. As an example, in an application involving both error detection and error mitigation, a first neural network can be trained and configured to receive input data and identify errors within the input data, and provide the output to a second neural network. The second can be trained and configured to receive data including identified errors, and select an error mitigation based on the type of error. In this way, multiple neural networks can be easily configured together to enable very powerful AI-enabled applications.

In embodiments, when the cursor 507 is placed over a layer, such as 502J, and a connected mouse is right-clicked, a popup menu 519 is rendered. Popup menu 519 can contain multiple options, including, but not limited to, delete layer, copy layer, edit layer, set input, and/or set output. Other embodiments may have more, fewer, and/or different options. The set input option enables specifying a layer from which input is received by the current layer (502J in this example). The set output option enables specifying a layer to which output is sent from the current layer (502J in this example).

Graphical editor environment 500 can include an import button 544. In embodiments, invoking the import button 544 provides a user interface for selecting training datasets. The user interface can include selection of folders and/or files containing training data such as images, video, audio, text, tables and Time series

Graphical editor environment 500 can include a train button 546. In embodiments, invoking the train button 546 provides a user interface for training the neural network depicted in FIG. 5. This can include performing supervised learning using the training datasets, which can include annotated images. Graphical editor environment 500 can include a deploy button 542. In embodiments, invoking the deploy button 542 causes the neural network depicted in FIG. 5 to be pushed to a cloud-based server and expose APIs for interacting with the neural network, including using the neural network to evaluate new data.

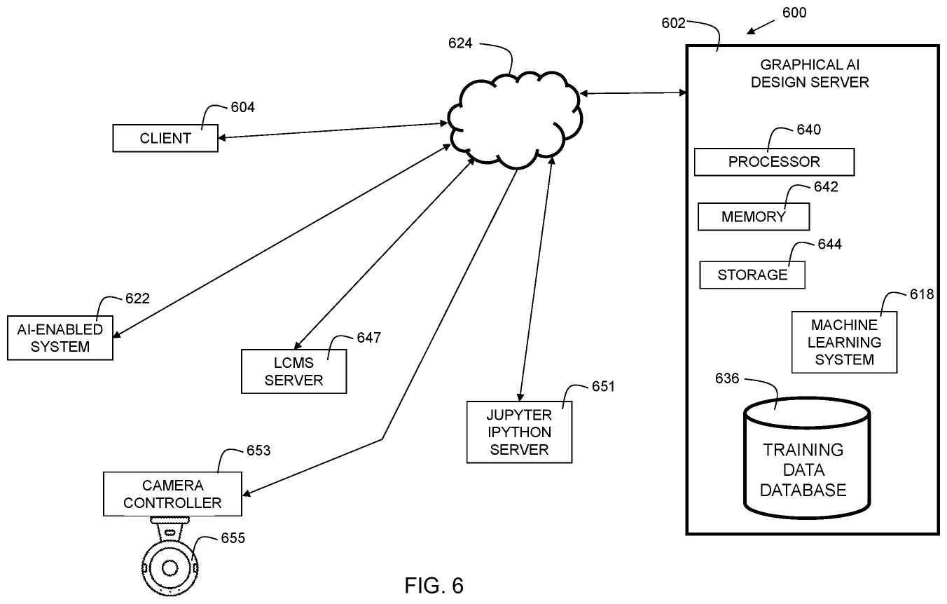

FIG. 6 shows a block diagram of additional embodiments. System 600 includes a graphical AI (artificial intelligence) design server (GAIDS) 602. GAIDS 602 is an electronic computing device. In embodiments, the GAIDS 602 is similar to GAIDS 102 of FIG. 1, and can be implemented as a computer comprising a processor 640, and memory 642 coupled to the processor. The memory 642 may be a non-transitory computer readable medium. Memory 642 may include RAM, ROM, flash, EEPROM, or other suitable storage technology. The memory 642 contains instructions that when executed by processor 640, enable communication with a variety of other devices and data stores. In embodiments, network 624 may include the Internet.

Storage 644 may include one or more magnetic hard disk drives (HDD), solid state disk drives (SSD), optical storage devices, tape drives, and/or other suitable storage devices. In embodiments, storage 644 may include multiple hard disk drives configured in a RAID (redundant array of independent disks) configuration, or other suitable configuration to ensure robust data integrity. In some embodiments, the GAIDS 602 may be implemented as a virtual machine (VM), or scaled to be implemented on multiple virtual machines and/or containerized applications. In some embodiments, the virtual machines may be hosted in a cloud computing environment. In some embodiments, load balancing, and orchestration via a system such as Kubernetes, enables a scalable solution that can process input data from a variety of sources simultaneously.

A client device 604 is also connected to network 624. In embodiments, client device 604 may include, but is not limited to, a desktop computer, a laptop computer, a tablet computer, a mobile phone (e.g., smartphone), and/or other suitable electronic computing device. Note that while one client device 604 is shown in FIG. 6, in practice, multiple client devices may concurrently establish connections with GAIDS 602 in accordance with embodiments of the present invention. In embodiments, the client device 604 can be used to interact with the GAIDS 602, to graphically build, train, and deploy neural networks.

System 600 may further include a training data database 636. The training data database 636 may comprise multiple records, where each record includes entities such as raw data, as well as metadata. The metadata may include descriptive tags and/or other classifications to organize the training data. In some embodiments, some of the training data may be used for validating a neural network.

System 600 further includes machine learning system 618. Machine learning system 618 can be used to categorize and classify input data by providing it to one or more prebuilt trained neural networks embedded into applications or custom-designed by a user from the scratch. The input data can include image data, video data, audio data, and/or other types of data, including data acquired from IoT sensors, humans, animals, scenery, object recognition and/or object classification, person recognition, natural language processing (NLP), sentiment analysis, and/or other classification processes. Machine learning system 618 may include one or more neural networks, convolutional neural networks (CNNs), and/or other deep learning techniques. The machine learning system 618 may include tools that allow management and control of regression algorithms, classification algorithms, clustering techniques, anomaly detection techniques, Bayesian filtering, and/or other suitable techniques to analyze the data provided to it.

System 600 may further include an AI-enabled system 622. The AI-enabled system can include network-enabled digital video cameras, audio sensors, robots, autonomous vehicles, and/or other systems that utilize AI for operation. Data from the AI-enabled system 622 via network 624 may be processed by machine learning system 618, results may be returned to the AI-enabled system via network 624. In embodiments, one or more APIs, and/or listeners may be established by the part of the GAIDS 602 via the machine learning system 618, to facilitate data and/or information exchange between the AI-enabled system 622 and GAIDS 602 machine learning system 618.

In some embodiments, the GAIDS 602 machine learning system 618, and/or database 636 via application programming interface (API) calls can interface with the AI client 604 and AI-enabled system 622. Communication between the elements shown in FIG. 6 can include the use of protocols such as HTTP (HyperText Transfer Protocol), XML (Extensible Markup Language), JSON (JavaScript Object Notation), SOAP (Simple Object Access Protocol), RESTful APIs, and/or other suitable technologies. The GAIDS 602 may include and/or utilize multiple computer systems, databases, load balancers, and other infrastructure to support analysis of data from the AI-enabled system 622.

System 600 may further include a Jupyter/IPython server 651. Jupyter and IPython are interactive computing environments that enable the execution of code, display of results, and processing of data in a flexible and interactive manner. Jupyter and IPython combine to form a tool suite that can be used to support data analysis, scientific computing, machine learning, and more. Jupyter is a web-based platform that enables users to create and share documents that contain live code, equations, visualizations, and narrative text. It supports a wide range of programming languages, including, but not limited to, Python, IPython, R, Julia, and others. IPython is a command-line interface (CLI) for interactive computing. In disclosed embodiments, IPython is used as a backend for interactive features, such as Jupyter and functionality provided by GAIDS 602. System 600 may further include a LCMS (Learning Content Management System) server 647. The LCMS 647 can be used to deliver knowledge about the system, and track the progress of learning and training for users to learn AI and neural network (NN) in disclosed embodiments, as well as the efficacy of trained models.

System 600 may further include a camera controller 653 that interfaces with a camera 655. The camera can include a digital camera. The digital camera can be used to capture data used to make the datasets. The digital camera can include a video camera, fixed focus camera, infrared camera, near field camera, or other suitable camera types. The camera controller may communicate with the GAIDS 602 via network 624 to send image data, report status, and/or receive control commands for establishing various photographic parameters such as light settings, apertures, shutter speeds, and the like. The camera 655 may be used in a computer vision application such as a manufacturing quality control inspection process. Disclosed embodiments can be used to detect defects and abnormalities in manufactured products, allowing for more accurate and consistent quality control. As an example, a manufacturing line may be used to paint parts with an automatic paint system. At times, the manufacturing line may paint parts sub-optimally. This can be due to variations in paint. When paint is too thick or too thin outside of its specifications, it can adversely affect coverage. Additionally, the painting equipment can have problems such as clogged nozzles, servo errors, and/or other problems. Disclosed embodiments can be used for an automated manufacturing inspection application by training a neural network on the appearance of properly painted workpieces and improperly painted workpieces. Once trained, disclosed embodiments can automatically inspect painted workpieces, and flag improperly painted samples. By automating tasks and increasing efficiency, disclosed embodiments can help to reduce production costs and improve profitability in a manufacturing application.

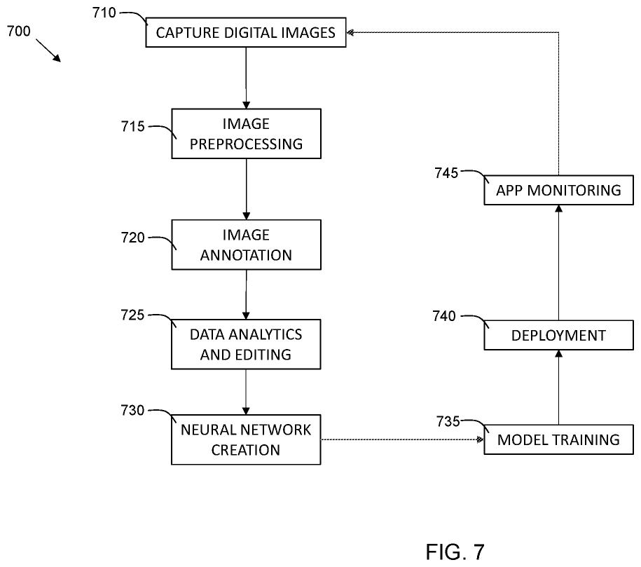

FIG. 7 is an AI application creation workflow 700 in accordance with disclosed embodiments. The workflow starts with capturing digital images 710. The digital images can be part of a video. The video can be a high-speed video. In some embodiments, the high-speed video can have a frame rate ranging from 1,000 frames per second (fps) to 2,500 fps. Other frame rates are possible in disclosed embodiments. The flow continues with image preprocessing 715. The image preprocessing can include various techniques used to prepare or transform raw images prior to labeling/categorizing of the images. One goal of preprocessing is to remove duplicate values, unified picture size and other visual parameters of the picture that could affect quality of the neural network model training and final result of the work of AI application. Outliers and inconsistent data points often tend to disturb the model's overall learning, leading to false predictions that improve the performance and accuracy of the model by making the input data more suitable for the model. Some of the techniques can include contrast adjustment, image cropping, straightening, color adjustment, resizing, noise filtering, normalization, color space conversion, augmentation and/or other preprocessing operations. The flow continues with image annotation 720. Data labeling refers to the process of adding tags or labels to raw data such as images, videos, text, and audio. This can include adding metadata to images. The metadata can be used for training neural networks. The metadata can include an error code. In embodiments, an error code of zero indicates no error. Other error codes can indicate a specific type of error. The errors can pertain to manufactured workpieces. Continuing with the example of automated painting, a first error code can be associated with an incorrect spray pattern, a second error code can be associated with an incorrect color, a third error code can be associated with paint streaks, and so on. The flow continues with data analytics and editing 725. The data analytics and editing can include grouping annotated images into success and failure cases used to create a training data set for supervised learning. The supervised learning can be based on a plurality of images of a manufacturing process. The plurality of images can include success workpieces and failure workpieces. The data analytics can also include detecting and removing dataset anomalies, as well as editing the data set by adding new images or removing images that increase error. The flow continues with neural network creation 730. The neural networks can include feedforward neural networks, Convolutional neural networks (CNNs), and/or other suitable neural network types. The neural network can include an input layer, an output layer, and one or more hidden layers. The flow continues with model training 735. The model training 735 can include training the neural networks with the captured digital images that have been preprocessed, annotated, edited, and/or organized. Once the model is trained, it is deployed at 740. The deployment can include deploying one or more servers in a cloud computing environment. The cloud computing environment can include one or more virtual machines and/or containerized environments. The deployed application can include the use of protocols such as HTTP (HyperText Transfer Protocol), XML (Extensible Markup Language), JSON (JavaScript Object Notation), SOAP (Simple Object Access Protocol), RESTful APIs, and/or other suitable technologies to provide access to the trained model from one or more client devices. The flow continues with app monitoring 745. The production process is continuously recorded by imaging hardware and captured data with newly discovered and recorded errors can be used to update and retrain the dataset and update the AI application functionality to find previously missed errors (manufacturing defects, for example). Additionally, the app monitoring can include monitoring metrics such as processor utilization, memory usage, network traffic, and/or disk I/O usage. Additionally, the app monitoring can include log file analysis, performance testing, and/or monitoring APIs to ensure that the deployed models and associated cloud platform applications are running properly. The flow may return to 710 and continue the flow depicted in FIG. 7 for multiple iterations to continuously train a neural network to perform a task such as automated manufacturing inspection and process monitoring. Each of the elements shown in FIG. 7 may be implemented as a distinct software tool.

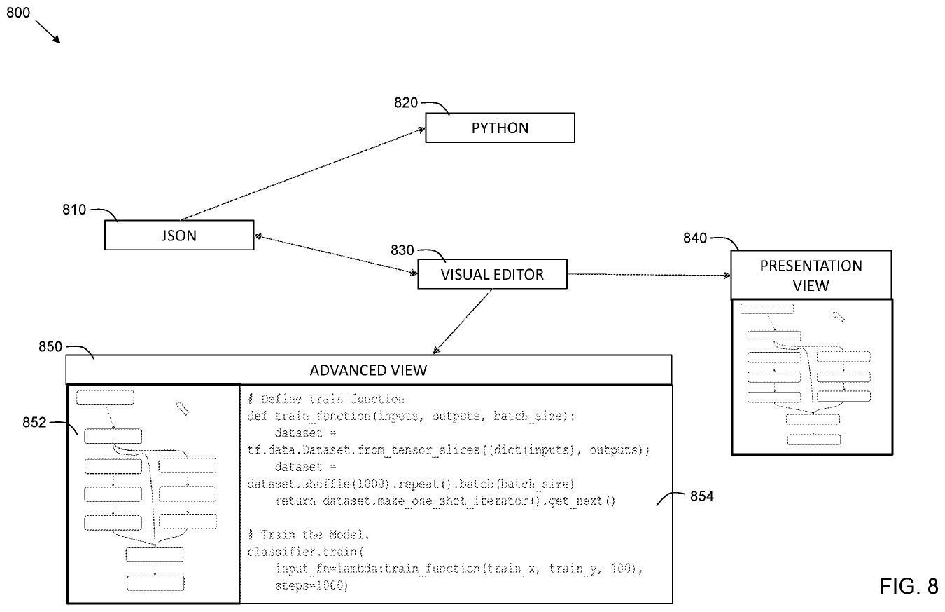

FIG. 8 is a block diagram 800 indicating a neural network design process in accordance with disclosed embodiments. Diagram 800 can include JSON data 810. JSON (JavaScript Object Notation) is a lightweight, text-based, language-independent data interchange format that is easy for humans to read and write and easy for machines to parse and generate. JSON files can be used to share data between a server and a web application. JSON files are used to store and transmit data as objects with attribute-value pairs and arrays. They can be used to represent simple or complex data structures, such as lists, dictionaries, or nested objects. In embodiments, the JSON files are used to transmit data between a server and a client, and/or to store data in a NoSQL database such as MongoDB. Programming languages and frameworks, such as JavaScript, Python, and Ruby, have built-in support for parsing and generating JSON, which makes it possible to use in a variety of contexts. The JSON data 810 can be parsed by python 820. Python can include multiple libraries and packages, including TensorFlow. TensorFlow is an open-source software library for machine learning and artificial intelligence. TensorFlow enables the building and training of machine learning models using a variety of different algorithms and techniques. It provides a variety of tools and libraries for building and training neural networks, as well as for performing other machine learning tasks such as data preprocessing, feature engineering, and model evaluation. It can be used to create machine learning models that are capable of handling large and complex datasets, and that can learn to recognize patterns and make predictions based on those patterns. Disclosed embodiments can deploy trained models to production environments, where they can be used to make real-time predictions or to perform other tasks.

The JSON data can be manipulated by visual editor 830. The visual editor 830 can support a visual programming environment. The visual editor 830 can render a graphical representation of a neural network model. The graphical representation can include a plurality of edges connecting one or more layers. The visual editor 830 can enable user editing of the graphical representation of the neural network. In embodiments, the visual editor 830 can save the graphical representation in a JSON format, and can be stored in JSON data 810. Disclosed embodiments provide visual programming for building AI applications. Visual programming is a programming paradigm that uses visual representations of code and data, rather than text-based programming languages, to create and manipulate software. The visual programming of AI systems is more intuitive and easier to use than traditional text-based programming languages. In embodiments, AI-based applications are created by dragging and dropping blocks or icons that represent different neural network components, such as input layers, activation functions, hidden layers, and output layers. These blocks can then be connected together via lines (edges) to form a visual representation of the neural network structure. The output of the visual editor 830 can include a presentation view 840 which the user can edit to configure the neural networks of disclosed embodiments. The output of the visual editor 830 can further include an advanced view 850 which the user can edit to configure the neural networks of disclosed embodiments. The advanced view shows both a graphical rendering 852, and a corresponding source code window 854 that shows code corresponding to the graphical rendering 852 that is displayed by the system through the website in a side-by-side view. In this way, advanced users can work in both windows simultaneously and see the changes they made in the graphic window simultaneously reflected in the code view window and vice versa.

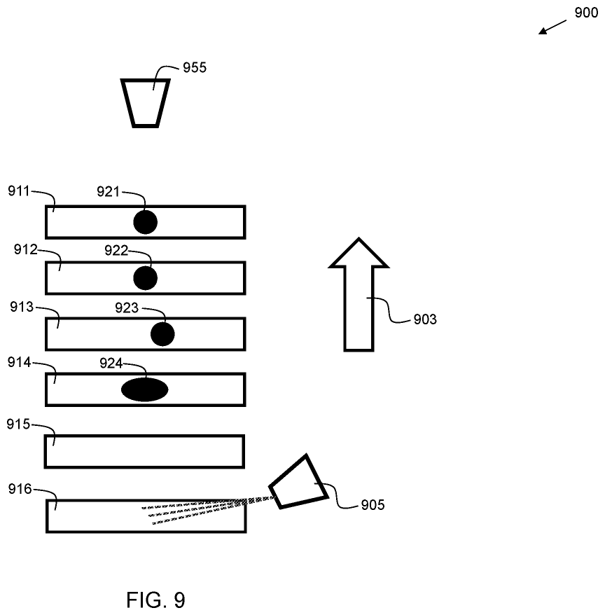

FIG. 9 is a diagram 900 indicating use of disclosed embodiments in a manufacturing application. Camera 955 is similar to camera 655 of FIG. 6, and connected to a system such as shown in FIG. 6. For clarity, in FIG. 9, only the camera 955 is shown, and the other parts of the system shown in FIG. 6 are omitted in FIG. 9. The camera is oriented to acquire images of a plurality of workpieces in a manufacturing process. The workpieces are indicated as reference numbers 911-916. The workpieces are passed within the field of view of camera 955 via a handling system (not shown) that moves the workpieces in the direction indicated by arrow 903, such that they pass through the field of view of camera 955 as they are moved. In embodiments, the handling system can be a conveyor belt or other suitable handling system. In the example of FIG. 9, each workpiece has a painted region formed thereon. The painted region can be formed by an automated paint sprayer 905 or other suitable apparatus. In the example, the painted region for a properly manufactured workpiece is a circle, as indicated by painted region 921 in the center of workpiece 911 and painted region 922 in the center of workpiece 912. As shown, the paint sprayer 905 is currently painting workpiece 916, and workpiece 915 skipped the painting process. The workpieces 911 and 912 are examples of properly fabricated workpieces. Workpiece 913 has painted region 923, which is in the proper circular shape, but off-center. Workpiece 914 has a properly centered painted region 924, but it is non-circular. Thus, workpieces 913 and 914 represent incorrectly fabricated workpieces. Similarly, workpiece 915 represents a defect since the painting process was skipped entirely. In embodiments, images of workpieces such as shown in FIG. 9 can be part of a training dataset. The training dataset includes images of proper workpieces such as workpiece 911 and workpiece 912, and various examples of improperly fabricated workpieces, such as workpieces 913, 914, and 915. Embodiments can include acquiring images of new workpieces; and classifying the images based on the neural network. Thus, once trained, disclosed embodiments can inspect workpieces in a manufacturing application, thereby improving overall product quality.

Embodiments can provide a computer-implemented method for designing a neural network, comprising: receiving a graphical representation of a neural network, wherein the graphical representation includes a plurality of layers; generating source code based on the graphical representation, wherein the source code implements the neural network; obtaining training data for training of the neural network; and deploying the neural network on a network-accessible server.

Disclosed embodiments provide the following features and advantages for visual dataset development that in embodiment conveniently provided by the system software tools in one place right under user fingertips that allow user without extra work of finding and implementing different tools and methods to:
Detect and edit anomalies in dataset parameters—using a graphical representation of the results for ease of analysis
Controls the correctness of markups—all marks are conveniently displayed on the images and can be edited.
Check dataset balance and displays the result of the analysis
Edit dataset—delete or add data items (images, videos)
Download annotations in VOC (Visual Object Classes) and/or COCO (Common Objects in Context) formats
Identify unmarked images and create a markup task

Additionally, disclosed embodiments include one or more software tools for various support activities. These can include, but are not limited to, manually searching for items of interest in the dataset, such as missing and/or damaged (imperfect) data samples. As examples, searching for images can be done based on an attribute such as searching for images that are too dark, overexposed, blurred, etc. For management of the converters, there is a software tool that allows installing, deleting, and/or editing of the converters. These tools can be implemented with a graphical user interface, thereby eliminating the need for users to perform direct coding.

For advanced users, disclosed embodiments provide side-by-side graphical and code-based environments. Disclosed embodiments enable users to build, edit, and manage datasets and models by using both graphical and code-based environments side by side. Machine code is generated based on the assembled graph that is created in a graphical mode. The machine code can be interpreted code such as Python. A plurality of pre-made datasets can be used to train the neural network. Once trained, the neural network is deployed by hosting it on a server and exposing one or more APIs and/or listeners to enable sending and receiving of data and information between the neural network and one or more AI-enabled systems.

As can now be appreciated, disclosed embodiments provide an improved technique for rapid development of neural networks, enabling streamlined deployment of AI-enabled systems. A graphical development environment allows users to design, train, and deploy a neural network without needing to write any code. This saves a considerable amount of time as compared with previous methods. Therefore, disclosed embodiments improve the technical field of dataset development, neural network design, training and deployment.

Although embodiments of the invention have been described herein as systems and methods, in some embodiments, the invention may include a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, and any suitable combination thereof. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network (for example, the Internet, a local area network, a wide area network and/or a wireless network). The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A computer-implemented method for creating a neural network, comprising:
receiving instructions for rendering a graphical representation of a dataset and neural network, wherein the graphical representation comprises a plurality of software tools for development of datasets and neural network nodes interconnected by a plurality of edges;
converting the graphical representation into source code;
training the neural network; and
deploying the neural network.

2. The method of claim 1, wherein the source code comprises python.

3. The method of claim 1, wherein the neural network comprises a convolutional neural network.

4. The method of claim 1, wherein neural network includes a convolutional 2D layer.

5. The method of claim 1, wherein the neural network includes a max pooling layer.

6. The method of claim 1, further comprising enabling user editing of the graphical representation.

7. The method of claim 6, further comprising saving the graphical representation in a JSON format.

8. The method of claim 1, wherein training the neural network comprises training the neural network using supervised learning.

9. The method of claim 8, wherein the supervised learning is based on a plurality of images of a manufacturing process.

10. The method of claim 9, wherein the plurality of images includes success workpieces and failure workpieces.

11. The method of claim 10, further comprising:
acquiring images of new workpieces; and
classifying the images based on the neural network.

12. An electronic computation device comprising:
a processor;
a memory coupled to the processor, the memory containing instructions, that when executed by the processor, cause the electronic computation device to perform the steps of:
receiving instructions for rendering a graphical representation of a neural network, wherein the graphical representation comprises a plurality of nodes interconnected by a plurality of edges;
converting the graphical representation into source code;
training the neural network; and
deploying the neural network.

13. The device of claim 12, wherein the memory contains instructions, that when executed by the processor, cause the electronic computation device to convert the graphical representation to python code.

14. The device of claim 12, wherein the memory contains instructions, that when executed by the processor, cause the electronic computation device to create a convolutional neural network.

15. The device of claim 12, wherein the memory contains instructions, that when executed by the processor, cause the electronic computation device to create a convolutional 2D layer.

16. The device of claim 12, wherein the memory contains instructions, that when executed by the processor, cause the electronic computation device to create a max pooling layer.

17. The device of claim 12, wherein the memory contains instructions, that when executed by the processor, cause the electronic computation device to save the graphical representation in a JSON format.

18. A computer program product for an electronic computation device comprising a computer readable storage medium having program instructions embodied therewith, the program instructions executable by a processor to cause the electronic computation device to:
receive instructions for rendering a graphical representation of a neural network, wherein the graphical representation comprises a plurality of nodes interconnected by a plurality of edges;
convert the graphical representation into source code;
train the neural network; and
deploy the neural network.

19. The computer program product of claim 18, further comprising program instructions, that when executed by the processor, cause the electronic computation device to create a convolutional 2D layer.

20. The computer program product of claim 18, further comprising program instructions, that when executed by the processor, cause the electronic computation device to create a max pooling layer.
